(19) United States
(12) Patent Application Publication
(10) Pub. No.: US 2023/0057387 A1
(43) Pub. Date: Feb. 23, 2023

(54) System and Method for Low Rank Training of Neural Networks

(71) Applicant: Cohere Inc., Toronto (CA)

(72) Inventors: Siddhartha Rao KAMALAKARA, Toronto (CA); Bharat VENKITESH, Toronto (CA); Aidan N. GOMEZ, Toronto (CA); Acyr Flavio Neto Locatelli, Cambridge (GB)

(73) Assignee: Cohere Inc., Toronto (CA)

(21) Appl. No.: 17/814,041

(22) Filed: Jul. 21, 2022

Related U.S. Application Data
(60) Provisional application No. 63/203,454, filed on Jul. 23, 2021.

(51) Int. Cl. G06N 3/08

(52) U.S. Cl. CPC G06N 3/08

(57) ABSTRACT

A method of training a neural network model and related systems are disclosed. The method includes training the neural network model by factorising, based on a singular value decomposition scheme, a first plurality of nodes of the neural network model into a low rank neural network model comprising a second plurality of nodes. Each node of the second plurality of nodes is defined at least in part by at least one weight matrix, and the factorisation is based on a matrix decomposition scheme constrained by one or more directionality criteria.

### CROSS REFERENCE TO OTHER APPLICATIONS

This application claims priority to U.S. Provisional Patent Application No. 63/203,454 filed on Jul. 23, 2021, the entire contents of which is incorporated herein by reference.

### TECHNICAL FIELD

The following generally relates to training neural networks, and more particularly to training neural networks with factorised layers.

### BACKGROUND

Recent developments in training very large vision and language models (alternatively referred to as neural networks), such as described in Brown et al., 2020; Fedus et al., and 2021; Dosovitskiy et al., 2020, have led to an increasing need for efficient training paradigms.

While low rank matrix factorisation of layers in a deep neural network may offer significant training speedups (up to 2×) and consume less memory when compared to unfactorized counterparts, matrix factorisation studies so far focused predominantly on linear networks and their applications to matrix sensing and matrix completion problems. Prior work in this space focuses on low-rank training in conjunction with additional training objectives or focuses on computing factorised approximations post-training. There has been limited prior work that focused on training dynamics for low rank deep neural networks.

For example, most works in the low rank space that focus on efficiency and speedups looked at post-hoc approximation of trained networks. (Yu et al., 2017) took an SVD free approach to reconstruct feature maps by minimising an objective that imposes sparse low rank structure. (Jaderberg et al., 2014) also considered a trained network upon which a low rank structure is imposed through filter and data reconstruction objectives. (Tai et al., 2016) focused on low rank training of CNNs from scratch; they proposed a horizontal and vertical filter decomposition of a convolutional kernel and reprojecting the same into orthogonal vectors at every step.

One of the reasons why prior work has focused on post-training low rank approximations is that training dynamics of neural networks are found to be poorly understood.

Naively training in the low rank space from scratch suffers a gap in performance. To resolve this, many recent attempts have been made to understand the implicit bias of gradient descent (GD) in matrix factorisation in both linear and non-linear networks. (Arora et al., 2019) investigated the behavior of GD in deep linear networks and found that as the depth of factorisation increases, GD tends to find low rank solutions Arora et al. also present evidence for the hypothesis that the language of norms such as nuclear norm, Frobenius norm, etc., may not be enough to describe the behavior of GD.

Martin & Mahoney, 2018 (Martin), presented an empirical analysis of commonly used architectures and characterised the dynamics of GD in deep non-linear networks in terms of Empirical Spectral Distributions (ESD) and phases of training. Martin defines a set of rank measures. Wang et al., 2021 used low rank training with unfactorized pre-training in the context of efficient communication in a distributed setting. Khodak et al., 2021 (Khodak) proposed a low rank training procedure by investigating initialisation and regularisation in factorised layers. Khodak analysed SVD based initialisation (Spectral Initialisation) and properties of L₂ regularisation. Khodak conjectures that there is an interplay between normalisation and weight decay and formalise this behavior through factorised update equations.

Despite the work to date, training dynamics of neural networks are found to be poorly understood. A problem associated with poorly understood training dynamics is that training performance is difficult to optimize in view of the difficulty to identify appropriate methods to optimize training.

### SUMMARY

In training very large vision and language models, the effects of factorised layers on optimisation may be non-trivial.

Disclosed herein are devices, methods and systems which disclose exemplary formulations for factorising layers of a neural network which may increase training speeds and reduce memory requirements associated with the neural network and/or address shortcomings of current low rank training methodologies.

This disclosure questions existing beliefs about why techniques like singular value decomposition (SVD) based initialisation and modified L₂ regularisation are effective. Starting with SVD based initialisation techniques which have been found to be effective in both low-rank and sparsity literature (Lee et al., 2019), random matrix theory is referred to in order to formally define the distribution of singular values at initialisation in modern neural networks and challenge prior assumptions on their importance. Empirical insights about the dynamics of singular values during training of an L₂ regularised network and a hypothesis about why L₂ regularisation on the re-composed matrix works better than L₂ regularisation on its factors is presented in this application. This application presents results contrary to currently held beliefs about effective step size and its correlation with performance. This application also presents results from empirical testing and analysis of existing methodologies of pre-training as a strategy to train better performing low rank networks. This application presents experiments which demonstrate the effectiveness and practicality of training low rank neural networks.

### BRIEF DESCRIPTION OF THE DRAWINGS

Embodiments will now be described with reference to the appended drawings wherein:

FIG. 1 is a schematic diagram of an example of a training system.

FIG. 2A is a schematic diagram of an example application in an image processing environment in which a trained model from the training system is applied to a data set.

FIGS. 2B and 2C are each a schematic diagram of an example application in a language processing environment in which a trained model from the training system is applied to a data set.

FIG. 3 is a chart comparing perplexity in a neural network model initialised with various initialisation schemes to required computing hours.

FIG. 4 is a chart comparing performance of a neural network model trained with various pre-training schemes.

FIG. 5 is a chart comparing perplexity in a neural network model initialised with various initialisation schemes to the total amount of parameters in the network.

FIG. 6 is a chart comparing performance of a neural network model trained with various pre-training schemes.

FIG. 7 is a chart comparing performance of a neural network model trained with various pre-training schemes.

### DETAILED DESCRIPTION

Training deep neural networks in low rank, i.e., with factorised layers, is of particular interest to the machine learning and artificial intelligence community: it offers efficiency over unfactorized training in terms of both memory consumption and training time. Prior work has focused on low rank approximations of pre-trained networks and training in low rank space with additional objectives, offering various ad hoc explanations for chosen practice. Techniques are analyzed that work well in practice, and through extensive ablations on models such as GPT2 evidence falsifying common beliefs in the field is provided hinting in the process at exciting research opportunities that still need answering.

The following describes a training system that programmatically factorises target deep neural networks to maximise efficiency while keeping performance loss minimal. The disclosed factorisation methodologies enable training low rank factorised neural networks to process, for example, very large vision and language models.

The proposed methodologies are based on selecting, controlling, or measuring directions of the singular values in SVD based initialisation for low rank training frameworks, and not, and previously stipulated, based solely on the values of the singular values. In experimental testing, models trained with SVD based initialisation with the singular values set to one exhibited superior performance to past models.

In addition to selecting, controlling, or measuring the directions of the singular values, this application proposes an at least two-phase training technique: a first phase which trains in the unfactorised space for a fraction of the total training, and (2) a subsequent phase which trains the model based on the low rank formulation methodologies set out herein. The proposed training technique, based on the low rank formulation methodologies, may allow for training large language models efficiently while keeping performance loss due to low-rank compression minimal.

In one aspect, a method of training a neural network model including a first plurality of nodes is disclosed. The method includes providing a training data set comprising a plurality of inputs and a corresponding plurality of expected results, and training the neural network model. The model is trained by factorising, based on a singular value decomposition scheme, the first plurality of nodes into a low rank neural network model comprising a second plurality of nodes such that each node of the second plurality of nodes is defined at least in part by at least one weight matrix. The factorisation is based on a matrix decomposition scheme constrained by one or more directionality criteria. The training includes iteratively updating a respective value of weight matrices of the second plurality of nodes based on an error determined by comparing a prediction of the low rank neural network model based on the input to the expected result corresponding to the input upon which the prediction is based. The method includes storing the trained low rank neural network model.

In example embodiments, the at least one weight matrix has a lower effective rank compared to the respective node of the first plurality of nodes.

In example embodiments, the method further includes constraining the factorising to a desired depth constraining a number of matrices to at least one matrix. In example embodiments, the desired depth is two.

In example embodiments, the one or more directionality criteria requires all values of the dimensional matrix to have a single value. In example embodiments, the single value of the dimensional matrix is one.

In example embodiments, the method further includes pre-training the neural network model for a subset of a number of desired training iterations.

In example embodiments, the method further includes, in response to determining an effective rank of the low rank neural network model is too low, increasing a rank of the at least one of the weight matrices in subsequent iterations.

In example embodiments, the method further includes transmitting the trained low rank neural network model to a third party.

In example embodiments, the method further includes receiving the training data from the third party.

In example embodiments, the method further includes processing one or more new data points with the trained low rank neural network model to generate a new prediction.

In another aspect, a computer readable medium comprising computer executable instructions for performing the method of any one of the precedingly described method aspects is disclosed.

In another aspect, a training system comprising a processor and memory is disclosed. The memory includes computer executable instructions for generating a trained model according to any one of the precedingly described training method aspects.

In another aspect, method of training a neural network model is disclosed. The method includes providing a first training data set, and training the neural network model by factorising the neural network model into a low rank neural network model comprising a plurality of nodes based on a singular value decomposition scheme. The method includes storing the trained low rank neural network model as the neural network model.

In another aspect, a predictive system comprising a processor and memory is disclosed. The memory includes computer executable instructions for processing one or more new data points with a low rank neural network model, wherein the low rank neural network model. The low rank neural network model trained by factorising a first plurality of nodes of a neural network model into a low rank neural network model comprising a second plurality of nodes based on a singular value decomposition scheme such that each node of the second plurality of nodes is defined at least in part by at least one weight matrix. The factorisation is based on a matrix decomposition scheme constrained by one or more directionality criteria.

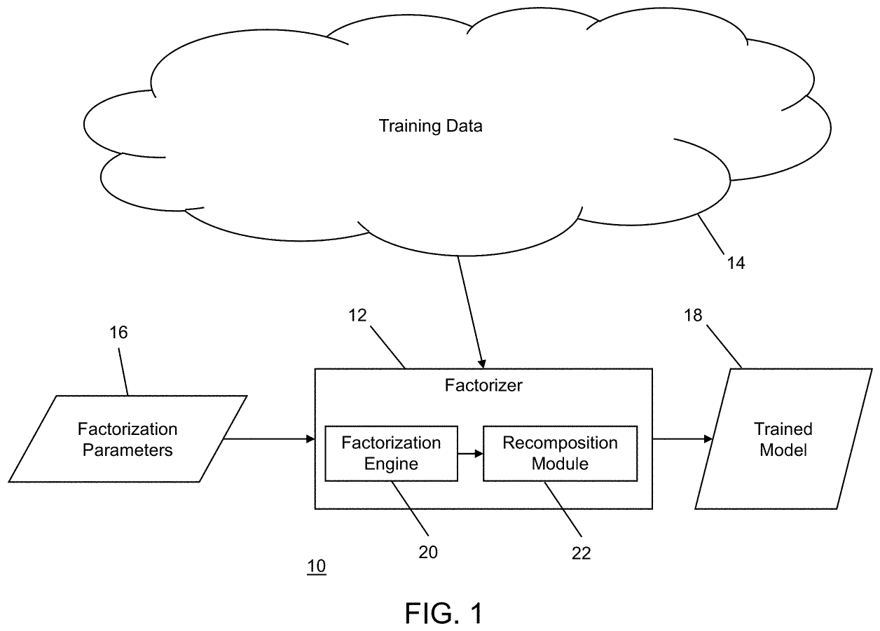

Turning now to the figures, FIG. 1 illustrates a computing environment which, in this example, can be considered a training environment or training system, used interchangeably herein, and denoted by numeral 10. The training system 10 includes a factoriser 12 that obtains or otherwise has access to a corpus of data 14, for example, various documents, pages, audio data, imaging data, generally any data that can be processed with image processing or language processing techniques, and other data available on the open web. It can be appreciated that data 14 can therefore be part of a different computing environment than the training system 10 but may also be part of the same environment or system. For example, the training system 10 can be deployed within an enterprise or organisation having its own unfiltered corpus of data 14 not relying on an outside source.

The factoriser 12 uses a set of factorisation parameters 16, as described further below (e.g., sections 3.1 to 5), to generate a trained model 18. As discussed below, the factoriser 12 may include multiple subcomponents to factorise a desired input neural network. In the example embodiment shown, the factoriser 12 includes a factorisation engine 20 which factorises layers of the deep neural network. Alternatively stated, the factorisation engine 20 may decompose the input neural network into one or more matrix representations which have a lower rank as compared to the input neural network. A recomposition module 22 can be used to recompose the decomposed matrix representations generated by the input neural network. The recomposition module 22 can be configured to only operate at the end of a training phase, recomposing the decompositions into the desired input neural network and incorporating weights learned by the decomposed matrix representations. The trained model 18 may be the decomposed matrix representation after the training phase, or the trained model 18 may be the recomposed desired input neural network after the training phase.

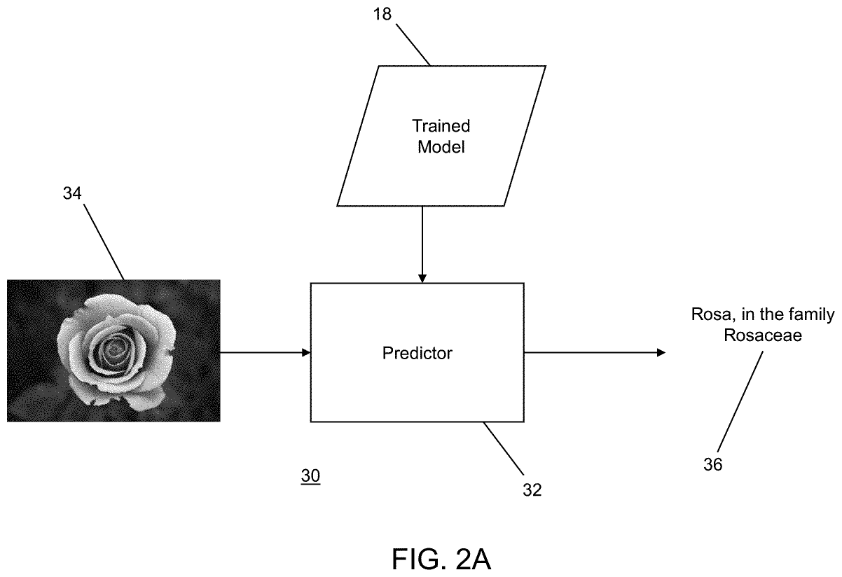

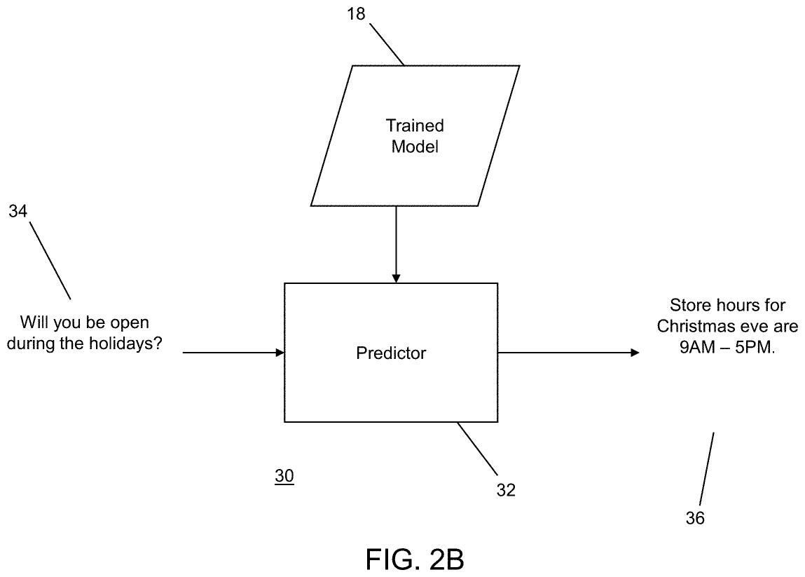

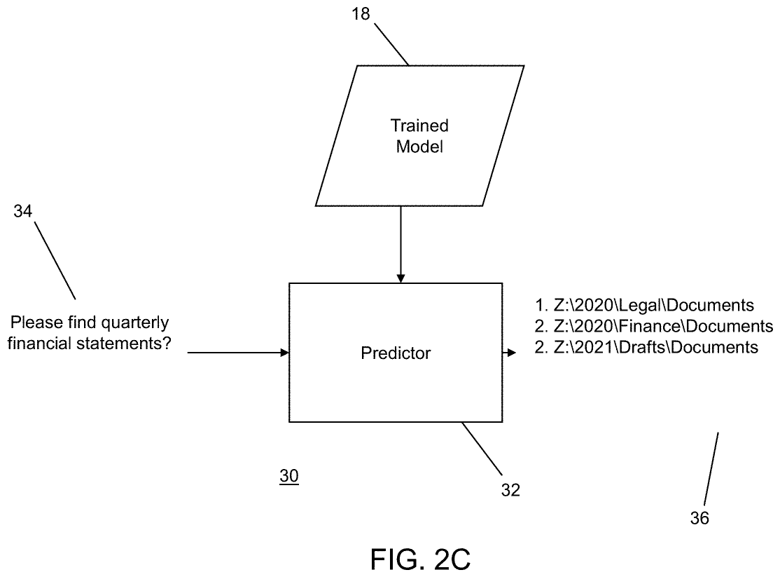

FIG. 2A provides an example of a computing environment that adopts or applies the trained model 18 in an application and can be referred to herein as an application environment 30. The application environment 30 includes a predicter 32 that is configured to use the pre-trained model 18 in classifying image data 34 to generate a categorization dataset 36.

In example embodiments, the trained model 18 can be adopted or applied in a language processing application. The predicter 32 is configured to use the trained model 18 to transform input textual data 34, into an output dataset 36 of semantically related text. In the example shown in FIG. 2B, the textual data 34 is a query, and the trained model 18 is embedded in a chatbot to generate semantically responsive answers to the questions. In the example shown in FIG. 2C, the trained model 18 may integrated within a search function, and process data stored on a database (not shown) to identify locations (e.g., output dataset 36) of documents semantically related to input textual data 34.

It will be appreciated that the trained model 18 may be stored in an environment separate from the application computing environment. For example, the application computing environment may be a retail environment, such as a ticket seller chatbot, an enterprise computing environment, or any third-party environment. The trained model 18 may be trained, updated, and stored on a separate computing environment, such as a Cohere.AI platform computing environment for serving to the third-party environments. In example embodiments, the trained model 18 stored on the separate computing environment receives inputs from the third-party application computing environment and outputs the prediction to the third party application computing environment for display. The trained model 18 may be trained by data provided by the third-party computing environment. For example, the third party may provide a set of common employee or customer queries for training.

In the foregoing, this application discusses the assumptions and conjectures associated with the low rank formulation in the context of SVD initialisation and L₂ regularisation.

### 3.1. Factorisation

In the disclosed experiments and analyses, a weight matrix W (e.g., the plurality of nodes of a neural network model) is factorised at each layer into two components U and V such that W=UV^{T}(where U and V are a plurality of nodes of a second, low rank neural node network). The focus of the experiments was on a factorisation depth of 2, taking into consideration memory speedup tradeoffs: As the depth of factorisation at each layer increases, more activations need to be stored in memory for back propagation. A depth of two provides speedups across all the experiments while ensuring minimal activation memory overhead. Consider the difference between the vanilla gradient descent update (unfactorised) Wₜ₊₁=Wₜ−α∇W and the update performed in the factorised setting:

$${W}_{t + 1} = {U}_{t + 1} {V}_{t + 1}^{T} \qquad ( 1 )$$

$${W}_{t + 1} = ( {U}_{t} - α ∇ U ) {( {V}_{t} - α ∇ V )}^{T}$$

$${W}_{t + 1} = {W}_{t} - α {\underbrace{( ∇ {W}_{t} {V}_{t} {V}_{t}^{T} + {U}_{t} {U}_{t}^{T} ∇ {W}_{t} )}}_{{∇}_{t}} + {α}^{2} ∇ {W}_{t} {W}_{t} ∇ {W}_{t}^{T}$$

Khodak extend the update equation above to normalised layers. Most modern architectures rely on normalisation layers to train networks that generalise well.

This includes batch normalisation (Ioffe & Szegedy, 2015) in ResNets and layer normalisation (Baet al., 2016) in Transformers. One can refer to Khodak for a more detailed discussion on the type and role of normalisation in factorised layers and use their formulation of the normalised update equation, which is given by:

$${\hat{w}}_{t + 1} = {\hat{w}}_{t} - \frac{α}{{‖ W ‖}_{F}^{2}} ( {I}_{mn} - {\hat{w}}_{t} {{\hat{w}}_{t}}^{T} ) {vec ( \hat{∇} )}_{t} + 𝒪 ( {α}^{2} ) \qquad ( 2 )$$

Where \hat{∇}t is ∇ₜ with gradients taken with respect to the normalised weight matrix

$$\hat{W} = \frac{W}{{‖ W ‖}_{F}} and \hat{w} = vec ( \hat{W} ) .$$

The gradient descent in the factorised setting does not perfectly align with the vanilla gradient descent update. In the subsequent sections, the disclosure empirically explores and works to overcome the implicit biases of this factorised update so that one can make low rank training an effective and efficient training method.

### 3.1.1. Fully Connected Layer

Let W∈R^{m×n} be the weight matrix of a fully connected layer. One can factorise W as W=UV^{T} with U∈R^{m×r} and V^{T}∈R^{r×n}, where 0<r<min(m, n). At inference, when

$$r < \frac{m \times n}{m + n} ,$$

factorising the fully connected weight matrix leads to a reduced memory footprint as well as floating point operations (flops from O(mn) to O(mr+rn). For training, the memory requirements change from O(mn+n) to O(mr+rn+n+r) to store the intermediate activations for backpropagation.

### 3.1.2. Convolutional Layer

The disclosed experiments factorise convolution kernels in a way that supports rewriting the single convolution as two convolutions. The convolutional kernel W∈R^{h×w×cin×cout} was factorized as W=UV^{T} with U∈R^{h×w×cin×r} and VT ∈R^{1×1×r×cout} where h, w represent the kernel height and width respectively, cin and cout represent the number of input and output channels respectively and r represents the rank of the decomposition. In the low rank decomposition, r≤min(h×w×cin,cout). This leads to a reduction in flops from O(hwcincout) to O(hwcinr+rcout).

### 3.2. SPECTRAL INITIALISATION

Khodak investigated the usefulness of spectral initialisation in low rank formulations of deep learning architectures and proposed a few hypotheses for why it works. This disclosure utilizes the same truncated SVD initialisation scheme, which is defined as follows:

$$\begin{matrix}{SVD}_{r} ( W ) = {\hat{U}}_{: r} {Σ}_{r} {\hat{V}}_{: r}^{T} , \\ U = {\hat{U}}_{: r} \sqrt{{Σ}_{r} ,} \\ V = {\hat{V}}_{: r} \sqrt{{Σ}_{r} ,}\end{matrix} \qquad ( 3 )$$

Where W is a matrix of shape N×M, U of shape N×r, V of shape M×r, Σ is the diagonal matrix of singular values and r is the rank chosen for the factorisation. Note that U and V are rectangular matrices unless specified otherwise.

Khodak analysed SVD based initialisation in the context of the update Equation 1 and provide two hypotheses forwhy this technique works, both of which are disproved via the experiments set out herein.

U₀U₀^{T}=V₀V₀^{T}=Σr.

In the low rank context, U and V are rectangular matrices obtained from truncated SVD which makes U and V column-wise orthogonal matrices. Therefore, UU^{T} and VV^{T} cannot be equal Σr and ∇W^{t}V^{t}Vₜ^{T}+UₜUₜ^{T ΣW}ₜ terms in the Equation 1 cannot be simplified.

The singular values of a Gaussian ensemble of scale1/√n are roughly distributed around 1. Marchenko-Pastur theory (described in Appendix A.1) is used to understand the distribution of singular values of a Gaussian ensemble matrix of size N×M, which states that the distribution of singular values is dependent on the scale of the random initialisation σ² and the size ratio N/M of the layer.

The disclosed experiments show that spectral initialisation works for reasons other than the ones stated in prior work. In Section 4.1, an ablation experiment is presented that hints at why this initialisation scheme performs better.

### 3.3. L2 Regularisation

Many architectures rely on L2 regularisation for better generalisation. The straightforward approach to impose L2 regularisation in a factorised network is to apply the Frobenius norm penalty to the factors U and V—that is,

$$\frac{λ}{2} ( {‖ ⋃ ‖}_{F}^{2} + {‖ V ‖}_{F}^{2} ) .$$

(Srebro & Shraibman, 2005) showed that this penalty minimises the nuclear norm of the recomposed matrix UV^{T}.

To address this, Khodak proposes penalising the Frobenius norm of the recomposed matrix UV^{T}, which they refer to as, Frobenius decay. They argue that Frobenius decay helps in keeping the effective step size high throughout training where effective step size is the term η/ ∥W∥²_{F} in Equation 2. It is shown, through an ablations study, that effective step size is an inadequate argument to justify the effectiveness of Frobenius decay over L₂ regularisation. It is pointed out that the dynamics of low-rank training with L₂ regularisation cannot be understood by only considering the normalised update Equation 2. This ignores the η^{λ}≈O(η²) terms arising from Frobenius norm penalty which have a non-trivial impact on the optimisation. It is found that the effectiveness of Frobenius decay over L₂ regularisation can be better explained by examining the effective rank of the network. The rank measure proposed in (Martin& Mahoney, 2018)is used, which defines effective rank of a matrix W to be:

$$\frac{‖ W ‖ *}{‖ W ‖ op} .$$

That is, the ratio between nuclear norm and the operator norm. In the present case, the effective rank of UV^{T} is interesting.

### 3.4. Pre-training

The initial stages of training are widely believed to be important for good performance in neural networks (Achille et al., 2017) (Frankle et al., 2019a). This motivates us to explore training for a fraction of the total training steps in the unfactorised space before switching to low rank substitutions of these unfactorised layers. One can apply the truncated SVD scheme described in Equation 3 to the partially trained weights to obtain the factors of the layer. Section 4.3 describes the impact of pre-training on performance across the vision and language experiments and analyses the nature of the solutions found with pre-training when compared to solutions found by low rank networks trained from scratch (Evci et al., 2019) (Frankle et al., 2019b).

### Example Algorithm

An example algorithm 1 of training the neural network in accordance with this disclosure is set out below:

Algorithm 1: Pre training algorithm

```
Input: N Randomly initialized weights of a network [symbol]
  = {W₁, W₂, ..., W_{N}}, total training epochs [symbol]  pre-training epochs [symbol]
  learning rate schedule [symbol]  optimizer O and loss function [symbol]
Result: A trained low rank neural network.
Set i ← [symbol]  ← False
while i ≤ [symbol]  do
```

| \| | if i ≤ [symbol] then | | | |
|---|---|---|---|---|
| \| | \| | Compute Loss, [symbol] [symbol] | | |
| \| | \| | Update weights, W ← O(W, [symbol] ) | | |
| \| | else | | | |
| \| | \| | if not d then | | |
| \| | \| | \| | for [symbol] do | |
| \| | \| | \| | \| | [symbol] = SVD( [symbol] ) |
| \| | \| | \| | \| | [symbol] |

| | | | |
|---|---|---|---|
| \| | \| | \| | end |
| \| | \| | \| | W = {U₁, V₁, U₂, V₂, ..., U_{N}, V_{N}} |
| \| | \| | \| | d ← True |

| | | |
|---|---|---|
| \| | \| | end |
| \| | \| | Compute Loss, [symbol] |
| \| | \| | Update weights, W ← O(W, [symbol] ) |

| | |
|---|---|
| \| | end |

end [symbol]
indicates data missing or illegible when filed

As shown in Algorithm 1, in a first phase, denoted by the loop including Iₚᵣₑ, the weights of the neural network model are trained according to traditional techniques.

In a second phase, the weights (i.e., nodes) of the neural network model are factorised or decomposed with a singular value decomposition scheme (denoted by SVD). The weights of the low rank neural network model (e.g., [symbol] ={U₁, V₁, U₂, V₂, . . . , U_{N}, V_{N}}), include at least one weight matrix for each node of the originally input neural network model. As set out herein, the weights of the low rank neural network model are determined based on factorisation of a respective node of the first plurality of nodes wherein the factorisation at least in part is based on the directional matrix Σₙ (alternatively referred to as directionality criteria). Σₙ in this example embodiment is shown as set to have all singular values set to one (1).

Once the neural network model has been factorised into the low rank neural network model (e.g., [symbol] ={U₁, V₁, U₂, V₂, . . . , U_{N}, V_{N}}), the low rank neural network model is trained for the remaining desired iterations (i.e., from i>Iₚᵣₑ to i=I).

In example embodiments, after the first two training phases, if the effective rank of the low rank neural network model is too low, training may either be restarted, or resumed with the at least one of the weight matrices being configured with a higher rank. In this way, iteratively, a low rank model with a sufficiently high effective rank may be achieved.

### 4. Experiments and Results

Extensive experiments were conducted on both vision and language models. For vision models, a Wide-ResNet-28 (Zagoruyko & Komodakis, 2016) on CIFAR-100 and a ResNet-50 (He et al., 2015) on the ImageNet dataset were used. For the language modelling task, experiments were conducted on one million word benchmark dataset (LM1B) (Chelba et al., 2013) and use the GPT-2 (Radford et al., 2019) architecture. Details on the complete experimental setup can be found in Appendix A.2. In the following sections, different initialisation schemes are compared and the effects of L2 regularisation and Frobenius decay is studied. Finally, it is demonstrated that the effectiveness of and analyse the nature of solutions found by—pre-training.

### 4.1. Initialisation

One can show that spectral initialisation offers equivalent performance when compared to traditional initialisation schemes.

Then, one can show empirically that the singular values do not play a major role in improving performance and that it is the direction of the singular vectors that matters. This finding is in contrast with prior beliefs (Khodak et al., 2021) about the role of singular values in retaining the scale of initialisation. One can establish this by setting the singular values to ones in Equation 3. Tables 2, 3, 4 compare the results across initialisation schemes on CIFAR100, ImageNet and LM1B respectively. It is observed that spectral ones leads to a better accuracy on CIFAR-100, lower perplexity on LM1B and a commensurate performance on ImageNet.

### 4.2. L2 Regularisation

The effective step size hypothesis can be investigated by training two networks, one with learning rate η and the other with

$$\frac{η}{2} .$$

So, the effective step size of these networks is

$$\frac{η}{{‖ W ‖}_{F}^{2}} and \frac{η}{2 {‖ W ‖}_{F}^{2}} /$$

respectively, based on Equation 2. If the hypothesis that a higher effective step size leads to better performance were true, it should be that halving the effective step size should lead to a lower performance, but it is found that

$$\frac{η}{2}$$

leads to models that are at least as good as models trained with learning rate η.

Tables 5, 6 and 7 compare the impact of effective step size on performance across CIFAR-100, ImageNet and LM1B respectively. Analysing the evolution of singular values in networks trained with L2 regularisation and Frobenius decay revealed that singular values are disproportionately affected in the case of L2 regularisation. It is observed that a “rich get richer, poor get poorer” phenomenon in L2 regularised networks causes the effective rank

$$\frac{{‖ {UV}^{T} ‖}_{*}}{{‖ {UV}^{T} ‖}_{op}}$$

of the network to drop because of the disproportionate increase in the operator norm of each layer. The averaged (across layers) effective rank at the end of training for the experiments are shown in Table 1.

TABLE 1
Effective rank measures for different models.

| Model | Dataset | Frobenius Decay | L₂ |
|---|---|---|---|
| WRN | CIFAR-100 | 39.87 | 16.4 |
| ResNet-50 | ImageNet | 68.72 | 58.00 |
| Transformer | LM1B | 206.93 | 205.70 |

### 4.3. Pre-training

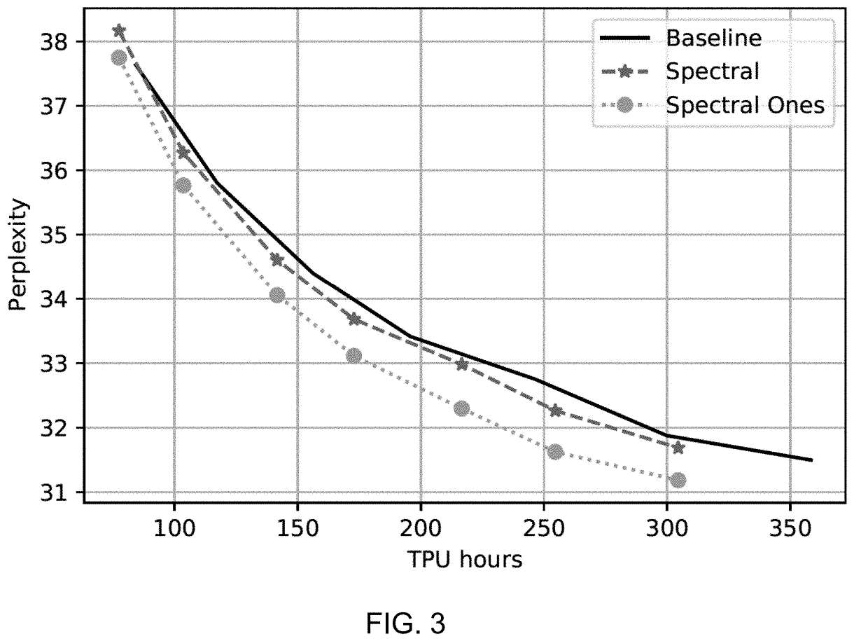

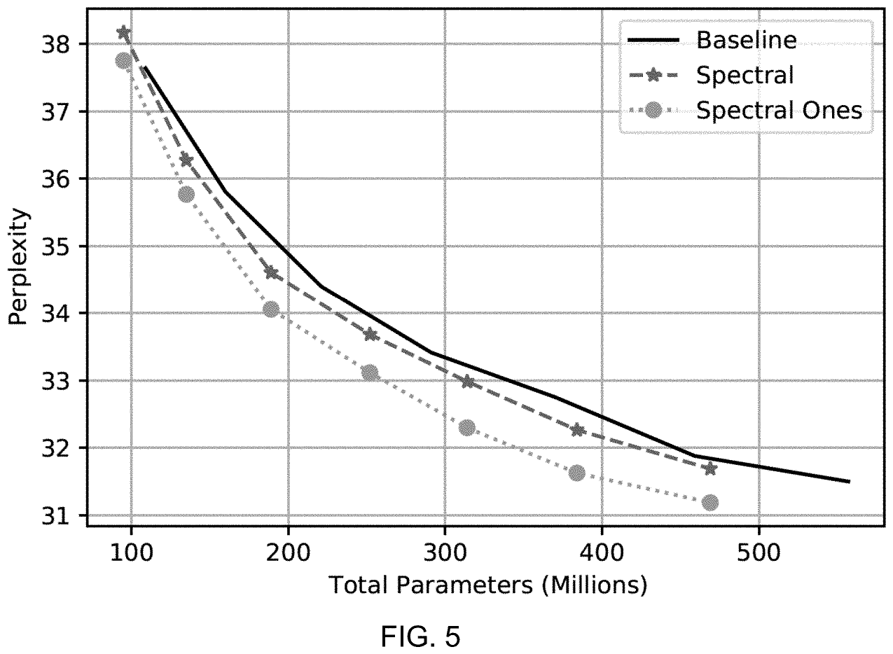

Pre-training networks for a fraction of the total training steps were investigated and it is observed that this leads to a significantly improved performance in the language model experiments as shown in FIGS. 3 and 5 when the model was scaled up. FIG. 3 shows TPU Compute hours vs Performance of GPT-2 on the LM1B data set as the model is scaled up. Each point on the line corresponds to a different model size starting from 1024 hidden dimensions (on the top left) to 2560 (on the bottom right) with increments of 256. FIG. 5 shows Total parameters vs Performance of GPT-2 on the LM1B as data set, as the model is scaled up. Each point on the line corresponds to a different model size starting from 1024 hidden dimensions (on the top left) to 2560 (on the bottom right) with increments of 256.

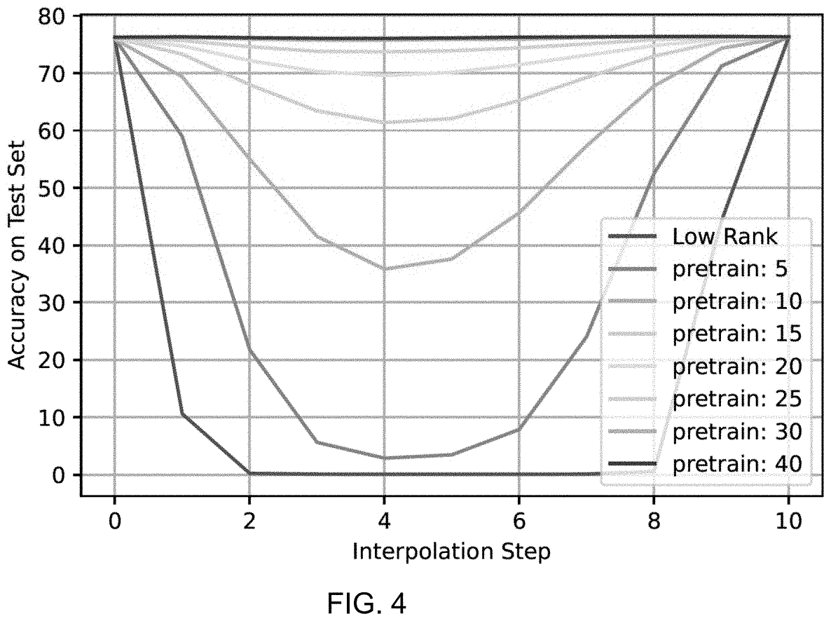

One can then pre-train in the unfactorised space for 40,000 steps and continue training in the factorised space for 200,000 steps. Pre-training can be combined with the techniques aforementioned viz Frobenius decay and resuming with decompositions obtained from Spectral and Spectral ones as described in 3.4. In the vision experiments, it is found that pretraining does not offer improved performance compared to a low-rank network trained from scratch as shown in Tables 8 and 9. Furthermore, it is noticed that the solutions found with pre-training are closer in the parameter space to their corresponding baseline (unfactorised) models. This can be demonstrated by performing linear interpolation, shown in FIGS. 4, 6 and 7, between pre-training and baseline weights by using the following equation: θ=(1 −t)θ_{b}+tθ_{I} for t∈ [0.0,1.0] with increments of 0.1 where t is the interpolation coefficient θ_{b} is the parameter from the baseline model and θ_{I} is the parameter from the low rank model with pre-training.

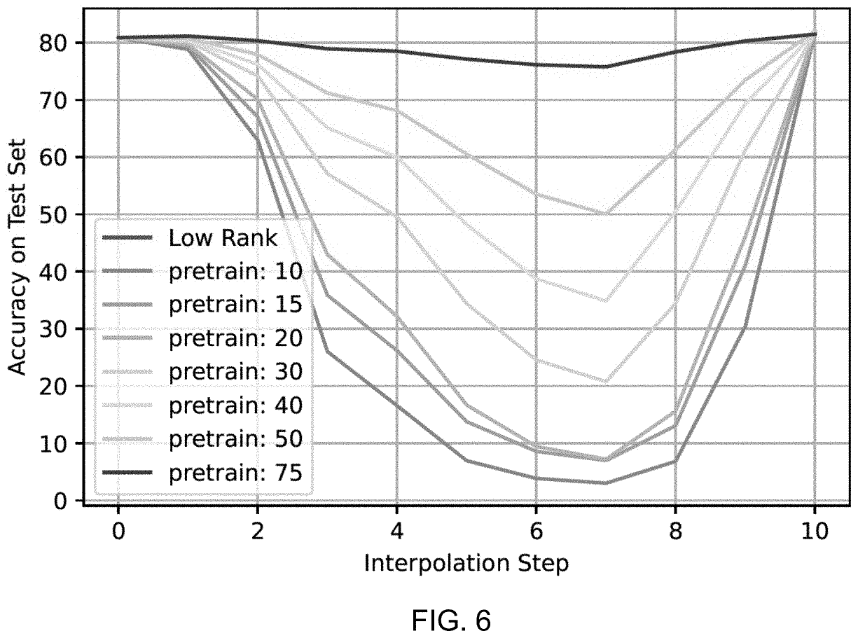

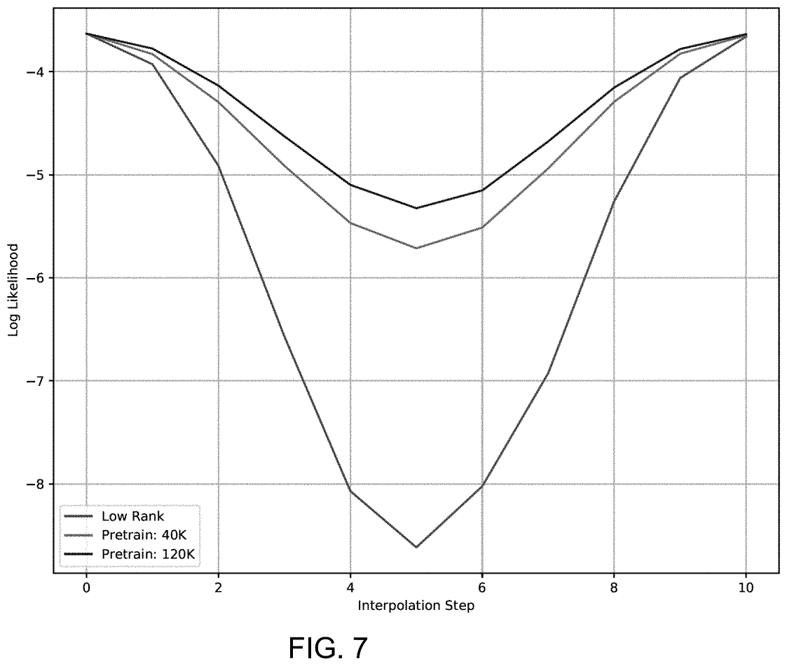

FIG. 4 shows a comparison of interpolation of low rank and pre-trained networks for ResNet-50 on ImageNet with a rank of 50% (with the graph showing results, from top to bottom, in the opposite order of their listing in the legend). FIG. 6 shows a comparison of interpolation of low rank and pre-trained networks for WideResNet-28 on CIFAR-100 with a rank of 30% (with the graph showing results, from top to bottom, in the opposite order of their listing in the legend). FIG. 7 shows a comparison of interpolation of low rank and pretrained networks for transformer LM (with the graph showing results, from top to bottom, in the opposite order of their listing in the legend).

### 5. Conclusion

It has been demonstrated empirically that Spectral initialisation and L2 regularisation on UV^{T} improve low-rank training but are poorly understood. Singular value analyses and ablation studies have been presented that act as counter-examples to prior beliefs about why these techniques work. Additionally, it has been demonstrated that pretraining can be an effective strategy to improve low-rank performance and presented insights on the nature of solutions found by networks with pretraining.

### References

Achille, A., Rovere, M., and Soatto, S. Critical learning periods in deep neural networks. CoRR, abs/1711.08856, 2017. URL http://arxiv.org/abs/1711.08856.

Arora, S., Cohen, N., Hu, W., and Luo, Y. Implicit regularization in deep matrix factorization, 2019.

Ba, J. L., Kiros, J. R., and Hinton, G. E. Layer normalization, 2016.

Brown, T. B., Mann, B., Ryder, N., Subbiah, M., Kaplan, J., Dhariwal, P., Neelakantan, A., Shyam, P., Sastry, G., Askell, A., Agarwal, S., Herbert-Voss, A., Krueger, G., Henighan, T., Child, R., Ramesh, A., Ziegler, D. M.,Wu, J.,Winter, C., Hesse, C., Chen,M., Sigler, E., Litwin,M., Gray, S., Chess, B., Clark, J., Berner, C., McCandlish, S., Radford, A., Sutskever, I., and Amodei, D. Language models are few-shot learners, 2020.

Chelba, C., Mikolov, T., Schuster, M., Ge, Q., Brants, T., and Koehn, P. One billion word benchmark for measuring progress in statistical language modeling. CoRR, abs/1312.3005, 2013. URL http://arxiv.org/abs/1312.3005.

Dosovitskiy, A., Beyer, L., Kolesnikov, A., Weissenborn, D., Zhai, X., Unterthiner, T., Dehghani, M., Minderer, M., Heigold, G., Gelly, S., Uszkoreit, J., and Houlsby, N. An image is worth 16×16 words: Transformers for image recognition at scale. CoRR, abs/2010.11929, 2020. URL https://arxiv.org/abs/2010.11929.

Evci, U., Pedregosa, F., Gomez, A. N., andElsen, E. The difficulty oft raining sparse neural networks CoRR, abs/1906.10732, 2019. URL http://arxiv.org/abs/1906.10732.

Fedus, W., Zoph, B., and Shazeer, N. Switch transformers: Scaling to trillion parameter models with simple and efficient sparsity CoRR, abs/2101.03961, 2021. URL https://arxiv.org/abs/2101.03961.

Frankle, J., Dziugaite, G. K., Roy, D. M., and Carbin, M. The lottery ticket hypothesis at scale. CoRR, abs/1903.01611, 2019a. URL http://arxiv.org/abs/1903.01611.

Frankle, J., Dziugaite, G. K., Roy, D.M., and Carbin, M. Linear mode connectivity and the lottery ticket hypothesis. CoRR, abs/1912.05671, 2019b. URL http://arxiv.org/abs/1912.05671.

He, K., Zhang, X., Ren, S., and Sun, J. Deep residual learning for image recognition. CoRR, abs/1512.03385, 2015. URL http://arxiv.org/abs/1512.03385

Ioffe, S. and Szegedy, C. Batch normalization: Accelerating deep network training by reducing internal covariate shift, 2015.

Jaderberg, M., Vedaldi, A., and Zisserman, A. Speeding up convolutional neural networks with low rank expansions, 2014.

Khodak, M., Tenenholtz, N. A., Mackey, L., and Fusi, N. Initialization and regularization of factorized neural layers. In International Conference on Learning Representations, 2021. URL https://openreview.net/forum?id=KTIJT1nof6d.

Lee, N., Ajanthan, T., Gould, S., and Torr, P. H. S. A signal propagation perspective for pruning neural networks at initialization. CoRR, abs/1906.06307, 2019. URL http://arxiv.org/abs/1906.06307.

Martin, C. H. and Mahoney, M. W. Implicit self-regularization in deep neural networks: Evidence from random matrix theory and implications for learning, 2018.

Radford, A., Wu, J., Child, R., Luan, D., Amodei, D., and Sutskever, I. Language models are unsupervised multitask learners. 2019.

Srebro, N. and Shraibman, A. Rank, trace-norm and max norm. In Auer, P. and Meir, R. (eds.), Learning Theory, pp. 545-560, Berlin, Heidelberg, 2005. SpringerBerlin Heidelberg. ISBN978-3-540-31892-7.

Tai, C., Xiao, T., Zhang, Y., Wang, X., and E, W. Convolutional neural networks with low-rank regularization, 2016.

Wang, H., Agarwal, S., and Papailiopoulos, D. Pufferfish Communication-efficient models at no extra cost 2021.

Yu, X., Liu, T., Wang, X., and Tao, D. On compressing deep models by low rank and sparse decomposition. pp. 67-76, 2017. doi: 10.1109/CVPR.2017.15.

Zagoruyko, S. and Komodakis, N. Wide residual networks. CoRR, abs/1605.07146, 2016. URL http://arxiv.org/abs/1605.07146.

### A. APPENDIX

### A.1. Marchenko-PasturTheory

Marchenko-Pastur (MP) theory defines the distribution of singular values of Gaussian random matrices in the infinite limit but is applicable to finite matrices with very reasonable error bounds. MP theory defines the distribution as:

$$ρ ( λ ) = \{ \begin{matrix}\frac{N}{2 {πσ}^{2} M} \frac{\sqrt{( {λ}^{+} - λ ) ( λ - {λ}^{-} )}}{λ} & if λ ∈ [ {λ}^{-} , {λ}^{+} ] \\ 0 & otherwise\end{matrix} \qquad ( 4 )$$

$${λ}^{\pm } = {{σ}^{2} ( 1 \pm \sqrt{\frac{M}{N}} )}^{2} , \qquad ( 5 )$$

### A.2. Experiment Details

For the language modelling task, the experiments were conducted on the one million word benchmark dataset (LM1B) (Chelba et al., 2013) and with the following set up: input sequence length is fixed at 25 and 1152 tokens for training and evaluation respectively and the vocab size is limited to 32K subwords and train all the models to 240K steps. A transformer language model was implemented on Tensorflow and run all the experiments on cloud TPUs. To have better savings on compute and memory the query, key value generation are combined into one weight matrix. For each transformer layer, three matrix operations: Q, K, V generation and the two fully connected layers are decomposed. Factorising the output projection layer is skipped and the combiner layer that combines the outputs of attention (this is a square matrix, and memory and compute benefit only for very small ranks). For all transformer runs, a rank of 62.5% is chosen, and half its baseline learning rate. For pre-training, 40K steps are trained unfactored, and then switched to low rank factorised training for the remaining 200K steps and halving the learning rate.

For the image classification task, experiments are conducted with CIFAR-100 and ImageNet. For CIFAR-100 the standard training/test split was used with a simple augmentation scheme—RandomCrop and Horizontal Flips. A WideResNet-28 (Zagoruyko & Komodakis, 2016) was trained for 200 epochs with SGD with momentum (0.9) and a batch size of 128. For regularisation, a weight decay coefficient of 5e-4 and no dropout was set. For the low rank training runs, every convolutional layer was factorized other than the first according to the factorisation scheme described above and the chosen rank. For ImageNet experiments, a standard ResNet-50 architecture was used and train on aTPUv2-8 with a per-core batch size of 128 and follow the same hyperparameters and learning rate schedule described in (He et al., 2015).

### A.3. Initialisation Results

Intialisation results of Wide Resnets onCifar-100

| Rank | Initialisation | Accuracy |
|---|---|---|
| Baseline (N/A) | He | 81.08 |
| 0.1 | He | 77.94 |
| | spectral | 79.84 |
| | spectral ones | 79.07 |
| 0.2 | He | 80.37 |
| | spectral | 81.35 |
| | spectral ones | 81.27 |
| 0.3 | He | 80.87 |
| | spectral | 81.53 |
| | spectral ones | 81.61 |

TABLE 3
Initialisation results of ResNet on ImageNet

| Rank | Initialisation | Top-1 | Top-5 |
|---|---|---|---|
| Baseline (N/A) | He | 76.39 | 93.21 |
| | He | 75.26 | 92.56 |
| 0.3 | spectral | 75.77 | 92.87 |
| | spectral ones | 75.71 | 92.82 |
| | He | 75.97 | 92,84 |
| 0.5 | spectral | 76.13 | 93.09 |
| | spectral ones | 75.98 | 92.97 |

TABLE 4
Initialisation results of Transformers on LM1B

| Rank | Initialisation | Perplexity |
|---|---|---|
| Baseline (N/A) | He | 37.67 |
| 0.62 | He | 39.6 |
| | spectral | 38.78 |
| | spectral ones | 38.47 |

### A.4. Regularisation Results

TABLE 5
Comparison between Frobenius Decay and
L2 regularisation onCifar-100

| Rank | Regularisation | Ir scaling | Accuracy |
|---|---|---|---|
| 0.1 | L2 | 0.5 | 73.12 |
| | | 1.0 | 72.59 |
| | Frobenius Decay | 0.5 | 79.84 |
| | | 1.0 | 79.79 |
| 0.2 | L2 | 0.5 | 78.22 |
| | | 1.0 | 77.56 |
| | Frobenius Decay | 0.5 | 81.35 |
| | | 1.0 | 81.61 |

TABLE 6
Comparison between Frobenius Decay and
L2 regularisation on Imagenet

| Rank | Regularization | Ir sealing | Top-1 | Top-5 |
|---|---|---|---|---|
| 0.3 | L2 | 0.5 | 75.11 | 92.42 |
| | | 1.0 | 74.9 | 92.24 |
| | Frobenius Decay | 0.5 | 75.22 | 92.49 |
| | | 1.0 | 75.77 | 92.87 |
| 0.5 | L2 | 0.5 | 75.04 | 92.36 |
| | | 1.0 | 74.83 | 92.25 |
| | Frobenius Decay | 0.5 | 75.97 | 92.85 |
| | | 1.0 | 76.13 | 93.09 |

TABLE 7
Comparison between Frobenius Decay
and L2 regularisation on LM1B

| Rank | Regularisation | Ir scaling | Perplexity |
|---|---|---|---|
| 0.62 | L2 | 0.5 | 38.87 |
| | | 1.0 | 39.01 |
| | Frobenius Decay | 0.5 | 38.78 |
| | | 1.0 | 39.2 |

### A.5. Pre-Training Results

TABLE 8
Pre-training results for Wide
ResNets onCIFAR-100

| Rank | Pre-training Epochs | Accuracy |
|---|---|---|
| 0.2 | 0 | 81.35 |
| | 15 | 81.33 |
| | 30 | 81.56 |
| | 40 | 81.53 |
| | 50 | 81.39 |
| | 75 | 81.53 |
| 0.3 | 0 | 81.53 |
| | 15 | 81.73 |
| | 30 | 81.51 |
| | 40 | 81.67 |
| | 50 | 82.0 |
| | 75 | 81.44 |

TABLE 9
Pre-training results for ResNet50 on ImageNet

| Rank | Pretrain epochs | Top-1 | Top-5 |
|---|---|---|---|
| 0.5 | 5 | 76.07 | 92.88 |
| | 10 | 75.96 | 93.04 |
| | 15 | 76.12 | 92.96 |
| | 20 | 76.08 | 92.94 |
| | 25 | 76.15 | 93.00 |
| | 30 | 76.05 | 92.9 |
| | 35 | 76.24 | 93.06 |
| | 40 | 76.21 | 93.09 |
| | 45 | 76.29 | 93.12 |

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the factoriser 12, application environment or other environment, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of training a neural network model including a first plurality of nodes, the method comprising:
providing a training data set comprising a plurality of inputs and a corresponding plurality of expected results;
training the neural network model by:
factorising, based on a singular value decomposition scheme, the first plurality of nodes into a low rank neural network model comprising a second plurality of nodes such that each node of the second plurality of nodes is defined at least in part by at least one weight matrix, wherein the factorisation is based on a matrix decomposition scheme constrained by one or more directionality criteria;
iteratively updating a respective value of the at least one weight matrix of the second plurality of nodes based on an error determined by comparing (i) a prediction of the low rank neural network model based on the input, to (ii) the expected result corresponding to the input upon which the prediction is based; and
storing the trained low rank neural network model.

2. The method of claim 1, wherein the at least one weight matrix has a lower effective rank compared to the respective node of the first plurality of nodes.

3. The method of claim 1, further comprising:
constraining the factorising to a desired depth by constraining a number of matrices of the at least one matrix.

4. The method of claim 3, wherein the desired depth is two.

5. The method of claim 1, wherein the one or more directionality criteria requires all values of a dimensional matrix of the low rank neural network model to have a single value.

6. The method of claim 5, wherein the single value of the dimensional matrix is one.

7. The method of claim 1, further comprising pre-training the neural network model for a subset of a number of desired training iterations.

8. The method of claim 1, further comprising, in response to determining an effective rank of the low rank neural network model is too low, increasing a rank of at least one of the at least one of the weight matrix in subsequent iterations.

9. The method of claim 1, further comprising transmitting the trained low rank neural network model to a third party.

10. The method of claim 1, further comprising receiving the training data from a third party.

11. The method of claim 1, further comprising processing one or more new data points with the trained low rank neural network model to generate a new prediction.

12. The method of claim 1, wherein the neural network processes at least one of language or image data.

13. A system for training a neural network model including a first plurality of nodes, the system comprising:
a processor;
a memory in communication with the processor, the memory comprising computer executable instructions that when executed by the processor cause the processor to:
provide a training data set comprising a plurality of inputs and a corresponding plurality of expected results;
train the neural network model by:
factorizing, based on a singular value decomposition scheme, the first plurality of nodes into a low rank neural network model comprising a second plurality of nodes such that each node of the second plurality of nodes is defined at least in part by at least one weight matrix, wherein the factorizing is based on a matrix decomposition scheme constrained by one or more directionality criteria;
iteratively updating a respective value of the at least one weight matrix of the second plurality of nodes based on an error determined by comparing (i) a prediction of the low rank neural network model based on the input, to (ii) the expected result corresponding to the input upon which the prediction is based; and
store the trained low rank neural network model.

14. The device of claim 13, wherein the at least one weight matrix has a lower effective rank compared to the respective node of the first plurality of nodes.

15. The device of claim 13, wherein the instructions cause the processor to constrain the factorizing to a desired depth by constraining a number of matrices of the at least one matrix.

16. The device of claim 15, wherein the desired depth is two.

17. The device of claim 13, wherein the one or more directionality criteria requires all values of a dimensional matrix to have a single value.

18. The device of claim 13, wherein the instructions cause the processor to, in response to determining an effective rank of the low rank neural network model is too low, increase a rank of at least one of the at least one of the weight matrix in subsequent iterations.

19. The device of claim 13, wherein the instructions cause the processor to process one or more new data points with the trained low rank neural network model to generate a new prediction.

20. A non-transitory computer readable medium for training a neural network model including a first plurality of nodes, the computer readable medium comprising computer executable instructions to:
provide a training data set comprising a plurality of inputs and a corresponding plurality of expected results;
train the neural network model by:
factorising, based on a singular value decomposition scheme, the first plurality of nodes into a low rank neural network model comprising a second plurality of nodes such that each node of the second plurality of nodes is defined at least in part by at least one weight matrix, wherein the factorisation is based on a matrix decomposition scheme constrained by one or more directionality criteria;
iteratively updating a respective value of the at least one weight matrix of the second plurality of nodes based on an error determined by comparing a prediction of the low rank neural network model based on the input to the expected result corresponding to the input upon which the prediction is based; and
store the trained low rank neural network model.
